(19) United States
(12) Patent Application Publication
(10) Pub. No.: US 2014/0001727 A1
(43) Pub. Date: Jan. 2, 2014

(54) FOOT PEDAL DRIVE AND PROPULSION DEVICE

(71) Applicant: Ping Sheng WU, Changhua (TW)

(72) Inventor: Ping Sheng WU, Changhua (TW)

(21) Appl. No.: 13/535,501

(22) Filed: Jun. 28, 2012

(51) Int. Cl. B62M 1/04

(52) U.S. Cl. 280/256

(57) ABSTRACT

A bicycle includes a front wheel attached to a front fork, a rear wheel attached to a rear fork, and a pair of cranks and a driving sprocket attached to a wheel hub of the bicycle frame, a foot pedal drive and propulsion device includes a shaft attached to the bicycle frame and located behind the rear wheel and disposed parallel to the rear wheel axle, a pair of levers each include a middle portion pivotally attached to the cranks and a rear portion slidably coupled to the shaft to form a retractable and telescopic structure, and a pair of foot pedals are adjustably attached to the front portions of the levers at selected positions for applying an increased driving torque to the cranks.

### BACKGROUND OF THE INVENTION

1. Field of the Invention

The present invention relates to a foot pedal drive and propulsion device, and more particularly to a foot pedal drive and propulsion device including an improved foot pedaling or driving mechanism for actuating or driving or operating the cranks with an increased driving torque and for allowing the cranks to be easily and kinematically driven or actuated by the user and for allowing the user to save labor and effort.

2. Description of the Prior Art

Typical bicycles comprise a front wheel and a rear wheel rotatably attached or mounted or secured to a bicycle frame at a front fork and a rear fork respectively, one or more driven sprockets attached or mounted or secured to a rear wheel axle of the bicycle, and a driving sprocket attached or mounted or secured to the bicycle frame and connected or coupled to the driven sprockets with a coupling chain, and a pair of cranks attached or mounted or secured to the driving sprocket and having foot pedal drive devices for rotating or driving the wheels of the bicycle.

For example, U.S. Pat. No. 594,980 to Booth et al., U.S. Pat. No. 2,424,639 to Sobirai, U.S. Pat. No. 2,391,809 to Wasem, U.S. Pat. No. 4,077,648 to Seul, and U.S. Pat. No. 4,666,173 to Graham disclose several of the typical foot pedal drive devices each comprising a pedal coupling or conversion mechanism for connecting or coupling to the cranks and for actuating or driving or operating the cranks with an increased driving torque and a decreased effort or labor or the like.

However, the pedal coupling or conversion mechanism may not be adjusted to different status and may not be suitably driven or actuated or operated by the user. In addition, the pedal coupling or conversion mechanism may not be easily and quickly and readily and directly attached or mounted or secured or coupled to the typical bicycle whose structure or configuration should be changed or modified vastly.

The present invention has arisen to mitigate and/or obviate the afore-described disadvantages of the conventional foot pedal drive and propulsion devices.

### SUMMARY OF THE INVENTION

The primary objective of the present invention is to provide a foot pedal drive and propulsion device including an improved foot pedaling or driving mechanism for actuating or driving or operating the cranks with an increased driving torque and for allowing the cranks to be easily and kinematically driven or actuated by the user and for allowing the user to save labor and effort.

The other objective of the present invention is to provide a foot pedal drive and propulsion device including a pair of foot pedals adjustably attached to the front portions of the driving levers at selected positions for adjusting the distance between the foot pedals and the cranks and for applying an increased driving torque to the cranks.

The further objective of the present invention is to provide a bicycle including a foot pedal drive and propulsion device easily and quickly and readily and directly attached or mounted or secured or coupled to the cranks of the typical bicycle without changing or modifying the configuration or structure of the typical bicycle.

In accordance with one aspect of the invention, there is provided a bicycle comprising a bicycle frame including a front fork and a rear fork, a front wheel rotatably attached to the front fork with a front wheel axle, a rear wheel rotatably attached to the rear fork with a rear wheel axle, at least one driven sprocket attached to the rear wheel axle, a driving sprocket attached to a wheel hub of the bicycle frame and coupled to the at least one driven sprocket with a coupling chain, a pair of cranks attached to the driving sprocket, and a foot pedal drive and propulsion device including a shaft attached to the bicycle frame and located behind the rear wheel and disposed parallel to the rear wheel axle, a pair of levers each having a middle portion pivotally attached to the cranks with pivot pins respectively, and each having a number of orifices formed in a front portion thereof, and each having a rear portion, a pair of rods slidably received or engaged in the levers respectively, and pivotally coupled to the shaft for forming a retractable and telescopic structure with the levers, and a pair of foot pedals engaged with either of the orifices of the levers for adjustably attaching the foot pedals to the front portions of the levers at selected positions from the pivot pins respectively.

The levers each include a longitudinal bore formed therein, a tubular member slidably received and engaged in the longitudinal bore of each lever and having a longitudinal hole formed therein for slidably receiving and engaging with the rod and for limiting and guiding the rod to slide and move relative to the tubular member and the lever respectively.

The shaft is attached to the rear fork of the bicycle frame with two arms. The levers each include a non-circular cross section. For example, the levers each include a cross section selected from a square or a rectangular cross section.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a partial exploded view of a foot pedal drive and propulsion device in accordance with the present invention;

FIG. 2 is a perspective view of the foot pedal drive and propulsion device;

FIG. 3 is a side plan schematic view of the foot pedal drive and propulsion device; and

FIGS. 4, 5, 6, 7 are side plan schematic views similar to FIG. 3, illustrating the operation of the foot pedal drive and propulsion device.

### DETAILED DESCRIPTION OF THE PREFERRED EMBODIMENT

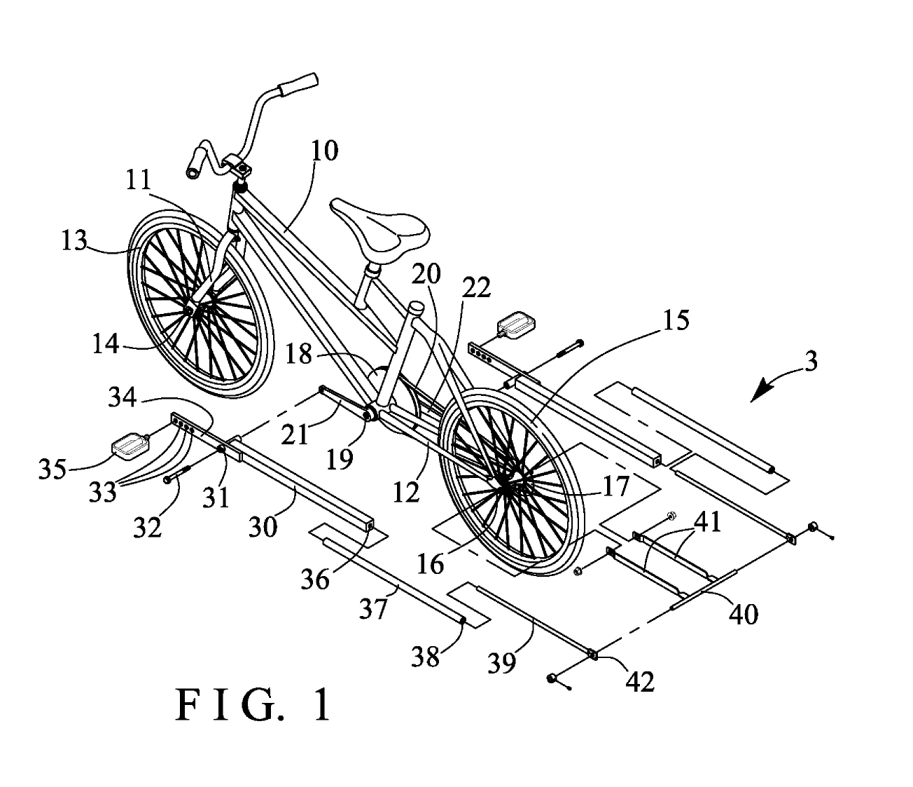

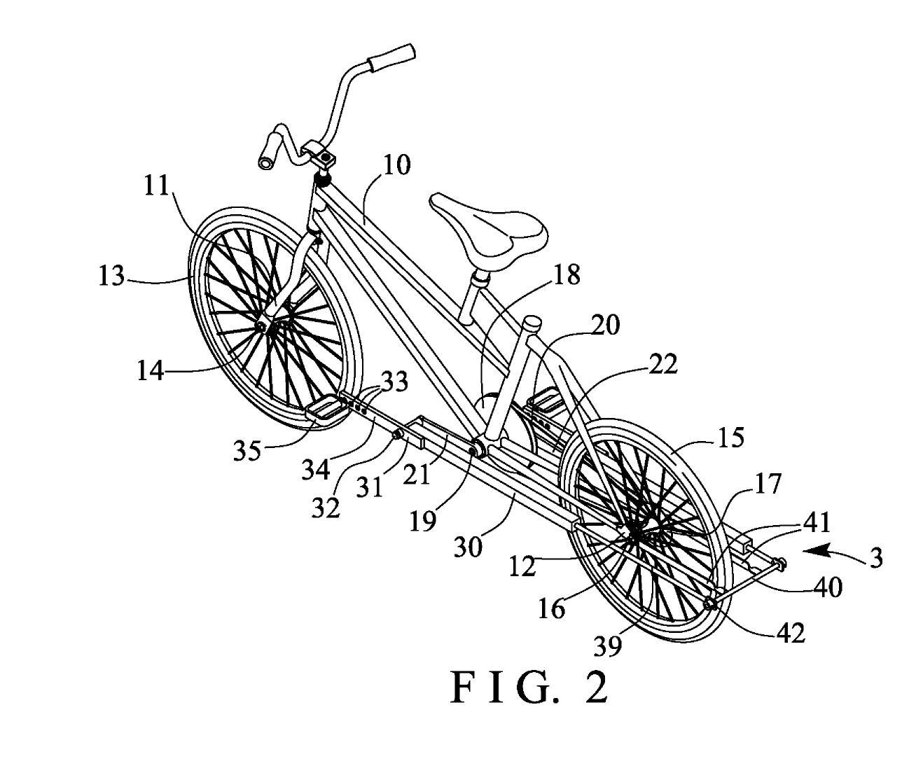

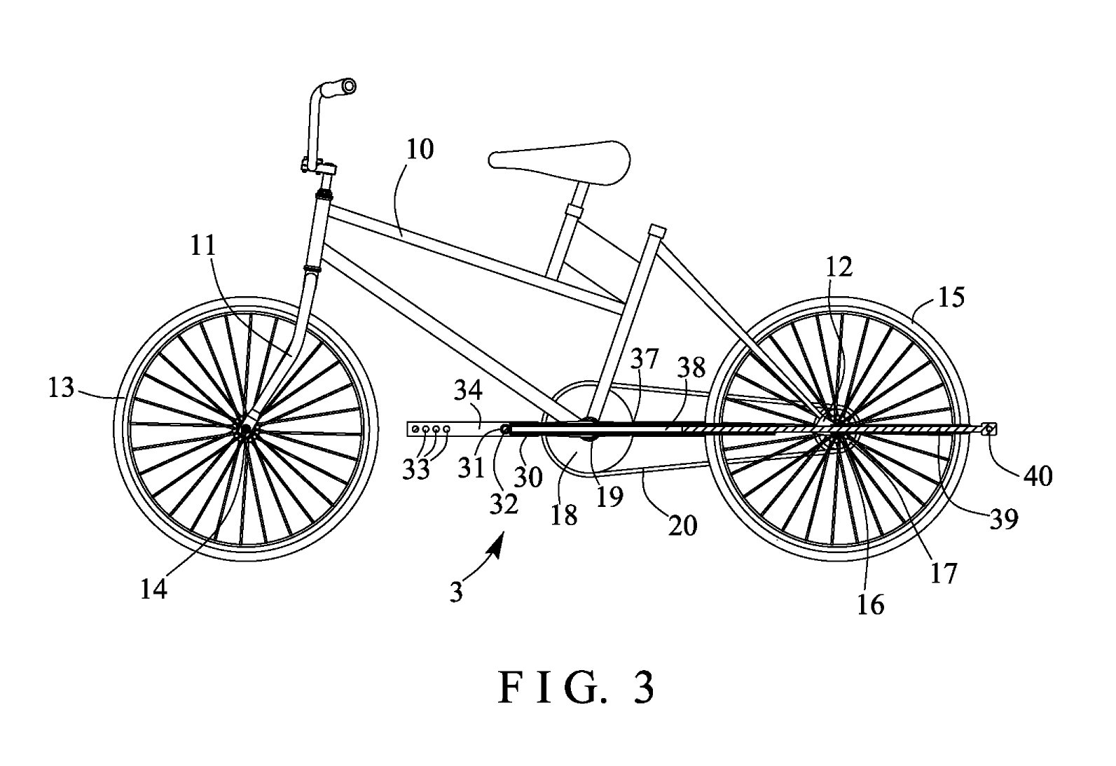

Referring to the drawings, and initially to FIGS. 1-3, a bicycle in accordance with the present invention comprises a bicycle frame 10 including a front fork 11 and a rear fork 12, a front wheel 13 rotatably attached or mounted or secured to the front fork 11 with a front wheel axle 14, and a rear wheel 15 rotatably attached or mounted or secured to the rear fork 12 with a rear wheel axle 16, one or more driven sprockets 17 attached or mounted or secured to the rear wheel axle 16 of the bicycle, and a driving sprocket 18 attached or mounted or secured to the bicycle frame 10 with or at a wheel hub 19 and connected or coupled to the driven sprockets 17 with a coupling chain 20, and a pair of cranks 21, 22 attached or mounted or secured to the driving sprocket 18 and/or the wheel hub 19. The above-described structure or configuration for the bicycle is typical and will not be described in further details.

The present invention further comprises a foot pedal drive and propulsion device 3 attached or mounted or secured or connected or coupled to the cranks 21, 22 of the typical bicycle for actuating or driving or operating the cranks with an increased driving torque, without changing or modifying the configuration or structure of the typical bicycle, the foot pedal drive and propulsion device 3 includes a pair or beams or levers 30 each having a front or middle portion 31 pivotally or rotatably attached or mounted or secured to the cranks 21, 22 with a pivot pin 32 respectively, and each having one or more orifices 33, such as a first orifice 33 and at least one second orifice 33 formed or provided in the front portion 34 thereof for changeably or adjustably engaging with a foot pedal 35 which may be stepped or engaged with the foot of the user for being stepped or actuated or operated by the user.

It is preferable, but not necessarily that the levers 30 each include a non-circular cross section, such as a square or rectangular cross section, and each include a longitudinal bore 36 formed therein for receiving or engaging with an insert or tubular member 37 which includes a longitudinal hole 38 formed therein for slidably receiving or engaging with a rod 39 and for limiting and guiding the rod 39 to slide and move relative to the tubular member 37 and the lever 30 respectively. For supporting the rods 39 and/or the levers 30, the foot pedal drive and propulsion device 3 further includes a shaft 40 attached or mounted or secured or coupled to the rear fork 12 and/or the bicycle frame 10 with a frame or one or more (such as two) arms 41, and located behind the rear wheel 15 and disposed or arranged parallel to the rear wheel axle 16 and/or the wheel hub 19 of the bicycle. The free or rear end portions 42 of the rods 39 are pivotally or rotatably attached or mounted or secured to the shaft 40. The tubular members 37 may be made or harder or stronger materials then that for the levers 30 for suitably and slidably receiving or engaging with the rods 39.

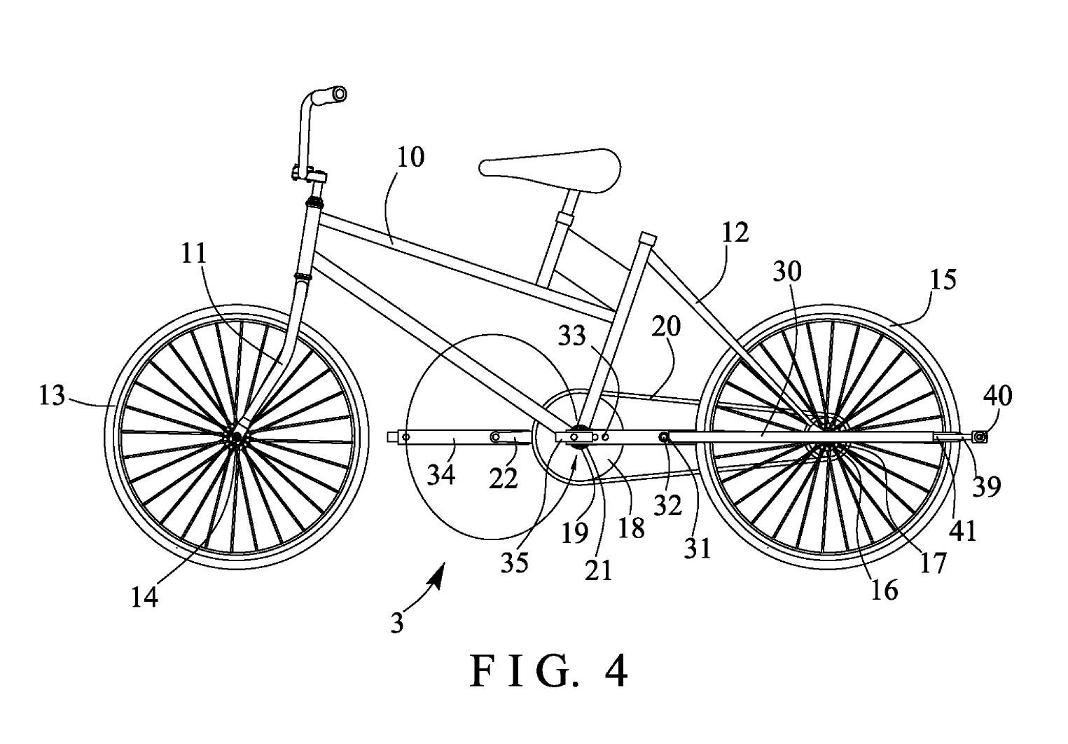

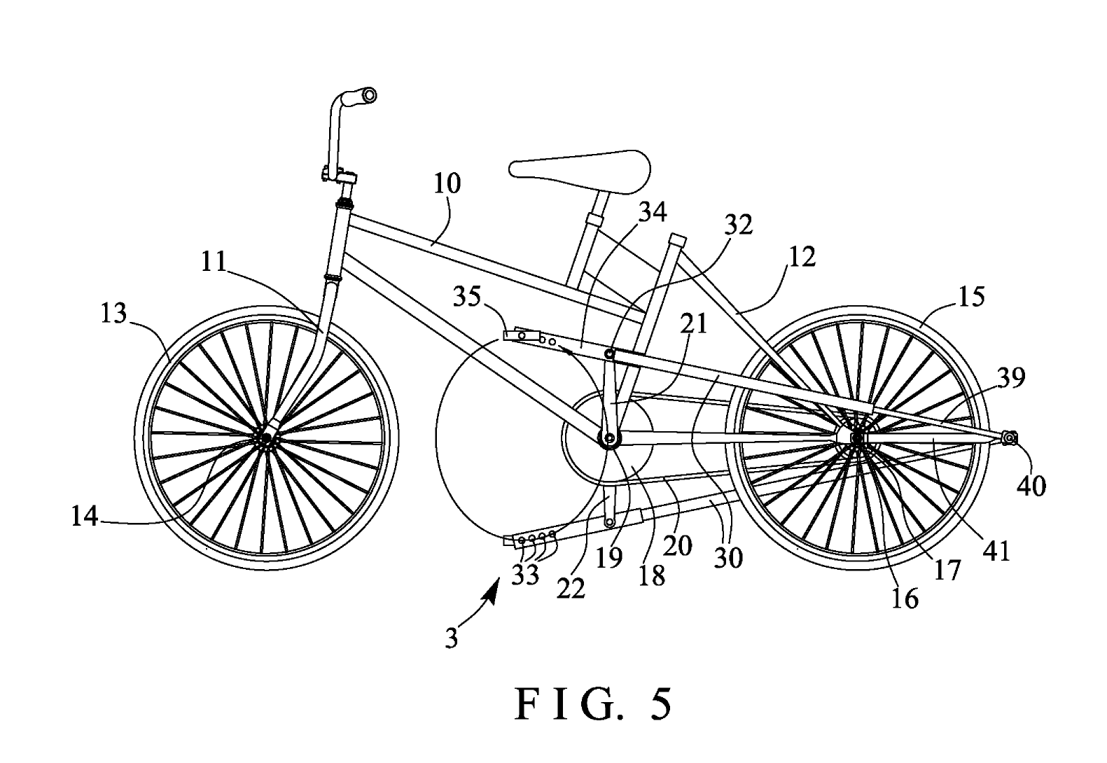

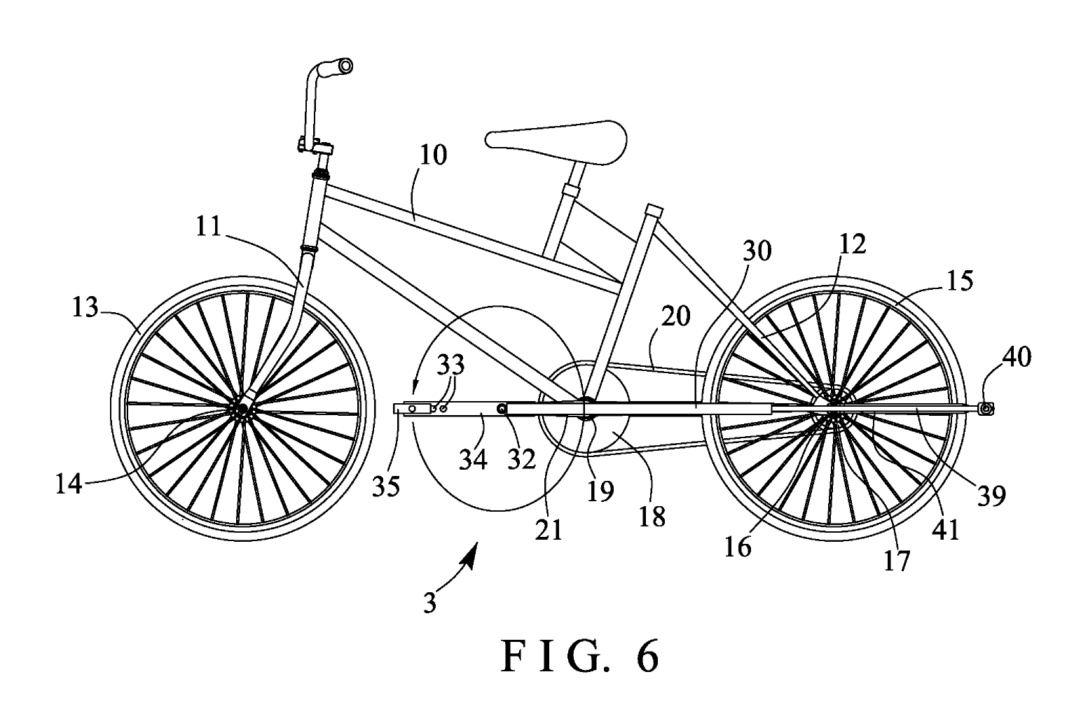

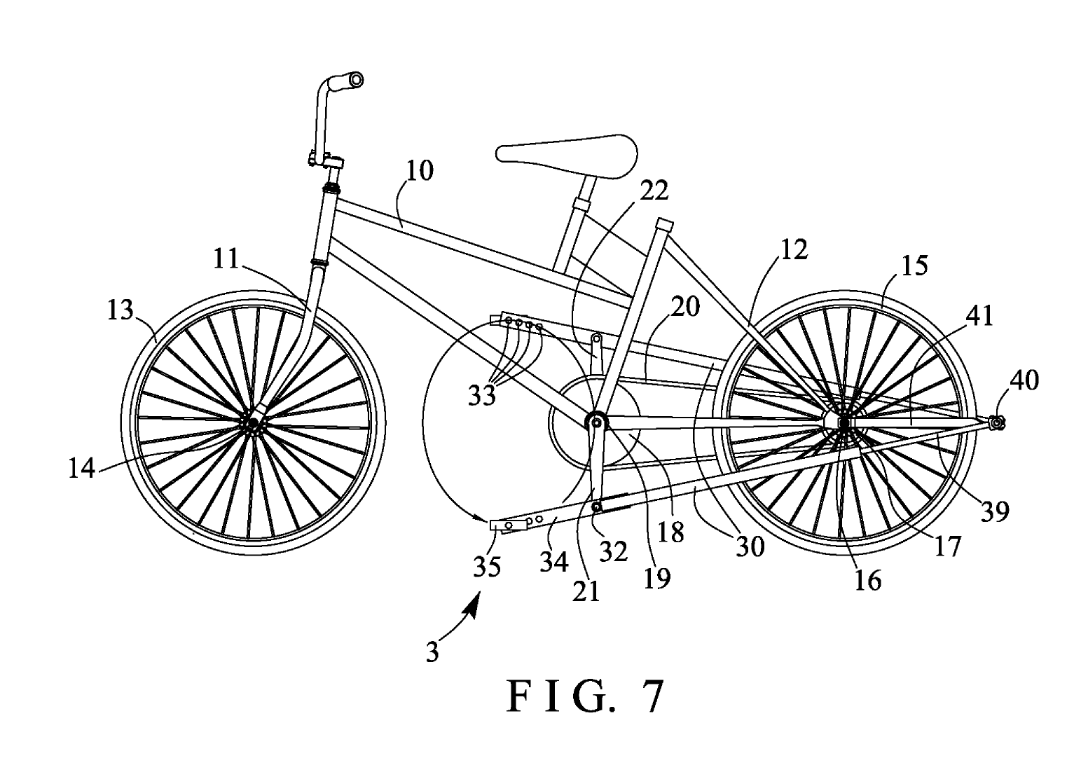

In operation, as shown in FIGS. 4-7, the user may step on the foot pedals 35 in order to move or actuate or operate or drive or rotate the levers 30 and the cranks 21, 22 relative to the wheel hub 19 in a reciprocating action, and the rods 39 are slidably received or engaged in the longitudinal holes 38 of the tubular members 37 respectively, or directly and slidably received or engaged in the longitudinal bores 36 of the levers 30 for limiting and guiding the rods 39 to slide and move relative to the tubular members 37 and the levers 30 respectively, and for preventing the levers 30 from being freely rotated relative to the cranks 21, 22. It is to be noted that the front portions 34 of the levers 30 are located or extended out of or away from the cranks 21, 22 and the pivot pins 32 and may apply an increased driving torque to the cranks 21, 22 and for allowing the cranks 21, 22 to be easily and kinematically driven or actuated by the user with a decreased labor and effort. It is further to be noted that the foot pedals 35 are changeably or adjustably engaged with either of the orifices 33 of the levers 30 for adjusting the distance between the foot pedal 35 and the pivot pin 32, and thus for adjusting the applying torque of the foot pedal 35 to the cranks 21, 22.

As also shown in FIGS. 4-7, the levers 30 and the rods 39 are slidable relative to each other for forming a retractable or telescopic structure, and the rods 39 are pivotally or rotatably attached or mounted or secured to the shaft 40 such that the levers 30 and the rods 39 are limited and guided to pivot or rotate relative to the shaft 40, and such that the foot pedals 35 are limited and guided to pivot or rotate in a circular or olivary or elliptical moving stroke. In addition the foot pedals 35 are offset or spaced from the pivot pins 32 for a suitable or selected distance and thus may apply an increased driving torque to the cranks 21, 22. Furthermore, the foot pedals 35 are changeably or adjustably engaged with either of the orifices 33 of the levers 30 for adjusting the distance between the foot pedal 35 and the pivot pin 32, and thus for adjusting the applying or driving torque of the foot pedal 35 to the cranks 21, 22, and thus for allowing the users of different strengths or heights, such as the children, the elders, the giants, or the like to suitable and selectively ride or drive the bicycle.

The arms 41 and the shaft 40 may be easily and quickly and readily and directly attached or mounted or secured or coupled to the rear fork 12 and/or the bicycle frame 10 with the arms 41, and the levers 30 may be easily and quickly and readily and directly attached or mounted or secured or coupled to the cranks 21, 22 when the foot pedals 35 are removed or disengaged from the cranks 21, 22, and the foot pedals 35 may then be changeably or adjustably engaged with either of the orifices 33 of the levers 30 for attaching or mounting or securing the foot pedals 35 to the levers 30 at selected or predetermined positions having different distances between the foot pedal 35 and the pivot pin 32, such that the foot pedal drive and propulsion device 3 may be easily and quickly and readily attached or mounted or secured or connected or coupled to the typical bicycle, without changing or modifying the configuration or structure of the typical bicycle.

Accordingly, the foot pedal drive and propulsion device in accordance with the present invention includes an improved foot pedaling or driving mechanism for actuating or driving or operating the cranks with an increased driving torque and for allowing the cranks to be easily and kinematically driven or actuated by the user and for allowing the user to save labor and effort, the foot pedals are adjustably attached to the driving levers at selected positions for adjusting the distance between the foot pedals and the cranks, and the foot pedal drive and propulsion device may be easily and quickly and readily and directly attached to the cranks of the typical bicycle without changing the configuration of the typical bicycle.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A bicycle comprising:
a bicycle frame including a front fork and a rear fork,
a front wheel rotatably attached to said front fork with a front wheel axle,
a rear wheel rotatably attached to said rear fork with a rear wheel axle,
at least one driven sprocket attached to said rear wheel axle,
a driving sprocket attached to a wheel hub of said bicycle frame and coupled to said at least one driven sprocket with a coupling chain,
a pair of cranks attached to said driving sprocket, and
a foot pedal drive and propulsion device including:
a shaft attached to said bicycle frame and located behind said rear wheel and disposed parallel to said rear wheel axle,
a pair of levers each having a middle portion pivotally attached to said cranks with pivot pins respectively, and each having a plurality of orifices formed in a front portion thereof, and each having a rear portion,
a pair of rods slidably received or engaged in said levers respectively, and pivotally coupled to said shaft for forming a retractable and telescopic structure with said levers, and
a pair of foot pedals engaged with either of said orifices of said levers for adjustably attaching said foot pedals to said front portions of said levers at selected positions from said pivot pins respectively.

2. The bicycle as claimed in claim 1, wherein said shaft is attached to said rear fork of said bicycle frame with two arms.

3. The bicycle as claimed in claim 1, wherein said levers each include a longitudinal bore formed therein, a tubular member slidably received and engaged in said longitudinal bore of each lever and having a longitudinal hole formed therein for slidably receiving and engaging with said rod and for limiting and guiding the rod to slide and move relative to the tubular member and the lever respectively.

4. The bicycle as claimed in claim 1, wherein said levers each include a non-circular cross section.

5. The bicycle as claimed in claim 4, wherein said levers each include a cross section selected from a square or a rectangular cross section.
